(19) United States
(12) Patent Application Publication
(10) Pub. No.: US 2026/0328052 A1
(43) Pub. Date: Oct. 22, 2026

(54) DECORATIVE CLIP AND CURTAIN

(71) Applicant: HANGZHOU GIPUTA CLOTHING CO., LTD., Hangzhou (CN)

(72) Inventors: Yu PAN, Hangzhou (CN); Michael Alexander MAYER, Hangzhou (CN)

(73) Assignee: HANGZHOU GIPUTA CLOTHING CO., LTD., Hangzhou (CN)

(21) Appl. No.: 19/352,270

(22) Filed: Oct. 7, 2025

(30) Foreign Application Priority Data
Oct. 12, 2024 (CN) 2024224656685

(51) Int. Cl. E06B 9/386; F16B 2/22

(52) U.S. Cl. CPC E06B 9/386; F16B 2/22

(57) ABSTRACT

A decorative clip and curtain, including a first structural member and a second structural member connected to the first structural member. When subjected to an external force, an angular change can occur between the first structural member and the second structural member. When the first structural member and the second structural member are positioned at a specific angle, a clamping force is generated between them, thereby allowing the clip to grip onto a sheet-like structure. A positioning structure for anti-slip purposes is provided on the side of the second structural member opposite to the side connected to the first structural member. The decorative clip allows decorative items to be attached to venetian blinds without interfering with the normal operation of the blinds.

### FILED OF THE INVENTION

The invention relates to curtain, and more particularly to decorative clip and curtain.

### BACKGROUND OF THE INVENTION

Sun-shading window decoration products can generally be categorized into venetian blinds, roller blinds, and fabric curtains. Among these, venetian blinds are widely used due to their features such as ventilation, breathability, and adjustable light control. However, in daily life, venetian blinds often lack interactive decorative functionality beyond their basic shading purpose. Different groups of people, such as children, may wish to attach cartoon figures or toys to the blinds. Similarly, during events like parties, people may desire to decorate the blinds with themed ornaments to enhance the atmosphere. However, such decorative additions often interfere with the normal operation of the venetian blinds.

### SUMMARY OF THE INVENTION

The objective of the present invention is to provide a decorative clip and a curtain, aiming to solve the technical problem in the prior art wherein attaching decorative items to venetian blinds adversely affects their normal operation.

To achieve the foregoing objective, the present invention adopts the following technical solution:

A decorative clip, comprising:
a first structural member and a second structural member connected to the first structural member;
wherein, when subjected to an external force, an angular displacement is generated between the first structural member and the second structural member;
when the first structural member and the second structural member are positioned at a specific angle, a clamping force is generated therebetween, thereby enabling the clip to grip onto a sheet-like structure;
wherein a positioning structure is disposed on the side of the second structural member opposite to the side connected to the first structural member, to prevent slippage.

Further, the first structural member is rigidly connected to one side of the second structural member.

Further, the first structural member is movably connected to one side of the second structural member.

Further, the first structural member is formed as a protrusion-shaped sheet, and the second structural member is a rectangular frame;

a protruding end of the protrusion-shaped sheet is connected to any position of the inner frame of the rectangular frame.

Further, when the decorative clip is clamped onto the sheet-like structure, the positioning structure is positioned higher than the edge of the sheet-like structure.

Further, the decorative clip comprising a decorative structure connected to the first structural member and/or the second structural member.

Further, the decorative structure is detachably connected to the first structural member and/or the second structural member.

Further, the decorative structure is connected to the first structural member and/or the second structural member via a connector.

A curtain, comprising any one of the foregoing decorative clip.

The beneficial effects of the decorative clip and curtain provided by the present invention are as follows:

Compared with the prior art, the decorative clip of the present invention enables various decorative items to be attached to venetian blinds without affecting the normal operation of the blinds. It is practical and commercially viable, while enhancing the decorative appearance of the blinds. The clip is easy and quick to operate, relatively safe to use, simple in structure, and low in manufacturing cost.

### BRIEF DESCRIPTION OF THE DRAWINGS

In order to more clearly illustrate the technical solutions in the embodiments of the present invention, the drawings required for describing the embodiments or the prior art are briefly introduced below. It should be understood that the drawings described below only illustrate some embodiments of the present invention. Those skilled in the art can derive other drawings based on these figures without engaging in inventive labor.

FIG. 1 is a schematic structural diagram of a decorative clip according to an embodiment of the present invention;

FIG. 2 is a schematic diagram showing the connection state of the decorative clip mounted on a sheet-like structure according to an embodiment of the present invention;

FIG. 3 is a schematic diagram illustrating different angles formed between the first structural member and the second structural member of the decorative clip, wherein the specific angle may vary according to the thickness of the blade;

FIG. 4 is a schematic structural diagram of another decorative clip according to an embodiment of the present invention;

FIG. 5 is a schematic structural diagram of yet another decorative clip according to an embodiment of the present invention;

FIG. 6 is a schematic diagram showing the connection state of a decorative clip mounted on a sheet-like structure according to an embodiment of the present invention;

FIG. 7 is a schematic diagram showing another connection state of a decorative clip mounted on a sheet-like structure according to an embodiment of the present invention;

FIG. 8 is a schematic diagram showing yet another connection state of a decorative clip mounted on a sheet-like structure according to an embodiment of the present invention.

### DESCRIPTION OF REFERENCE NUMERALS

1—first structural member; 2—second structural member; 21—positioning structure; 3—decorative structure; 4—sheet-like structure.

### DETAILED DESCRIPTION OF THE PREFERRED EMBODIMENTS

In order to make the technical problem to be solved, the technical solution, and the beneficial effects of the present invention more apparent, the invention is further described in detail below in conjunction with the drawings and specific embodiments. It should be understood that the specific embodiments described herein are merely intended to illustrate the invention and are not to be construed as limiting its scope.

It should be noted that the terms “first,” “second,” and the like as used in the specification and claims of the present application are intended solely to distinguish similar elements and are not meant to indicate any particular order or sequence. Such terms should be understood as interchangeable where appropriate so that embodiments of the present application may be practiced in orders other than those illustrated or described herein. Moreover, elements distinguished as “first” and “second” typically belong to the same category and are not limited in number; for example, the “first” object may refer to one or more objects. In addition, the term “and/or” as used in the specification and claims indicates that one or more of the listed elements may be included. The character “/” generally denotes an “or” relationship between the associated elements.

In daily life, venetian blinds may sometimes require decorative elements to be added. The purpose of the present invention is to provide a decorative clip that allows various decorative items to be securely attached to venetian blinds, thereby enhancing the aesthetic appeal of conventional blinds. The decorative clip is convenient to use and does not interfere with the normal operation of the blinds. In addition, it is user-friendly, safe, widely applicable, and low in manufacturing cost.

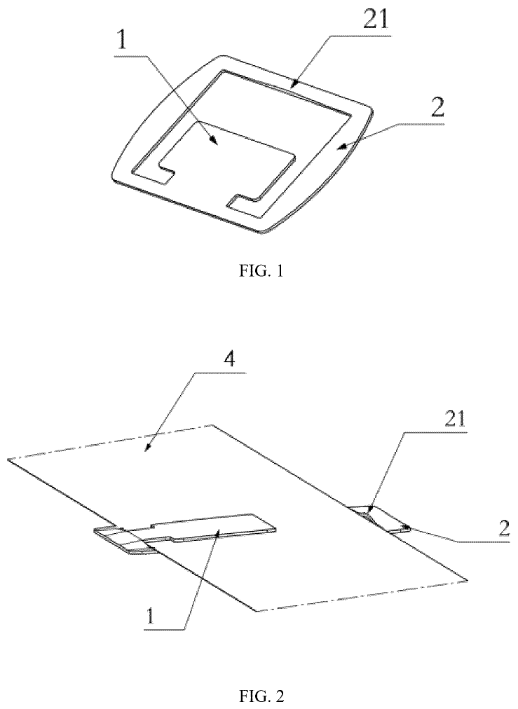

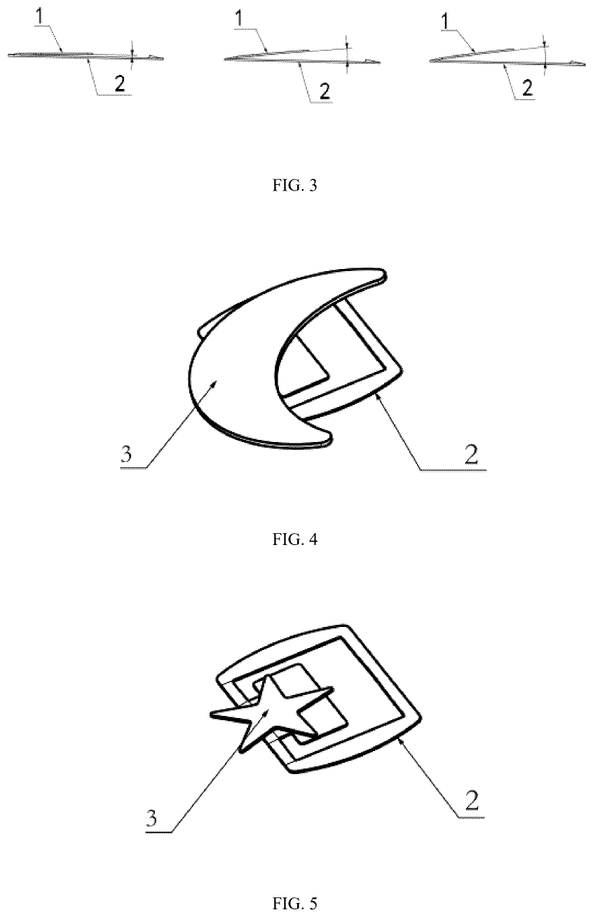

Referring to FIGS. 1 to 8, a decorative clip according to an embodiment of the present invention is described. The decorative clip comprises a first structural member 1 and a second structural member 2 connected to the first structural member 1. When subjected to an external force, a change in angle can occur between the first structural member 1 and the second structural member 2. When the first structural member 1 and the second structural member 2 are at a specific angle, a clamping force is generated between them, thereby allowing them to grip onto a sheet-like structure 4.

By the cooperation between the first structural member 1 and the second structural member 2, the clip can clamp the slat (i.e., the sheet-like structure 4) from its upper and lower surfaces, thereby achieving the purpose of fixing the decorative clip onto the venetian blind (the venetian blind including multiple slats). Furthermore, the decorative clip can move along with the motion of the sheet-like structure 4 (such as a slat).

In some implementable embodiments, one side of the first structural member 1 is connected to the second structural member 2 via a rigid or movable connection, such as a hinge or a rotating shaft. This configuration allows a clamping force to be generated between the first structural member 1 and the second structural member 2 when they form a specific angle, thereby enabling the clip to grip onto the sheet-like structure 4.

In any implementable embodiment, please refer to FIG. 1, the first structural member 1 is a protrusion-shaped sheet member, and the second structural member 2 is a rectangular frame. The protruding end of the protrusion-shaped sheet is rigidly connected to any position on the inner frame of the rectangular structure. The first structural member 1 possesses a certain degree of elasticity. Specifically, the first structural member 1 is made of one or more materials selected from spring steel and plastic polymers. The first structural member 1 and the second structural member 2 are integrally formed. An angular displacement can occur between the first structural member 1 and the second structural member 2. Specifically, when the first structural member 1 is subjected to force, it bends to form an angle with the second structural member 2 and generates a clamping force. Once the force is removed, the first structural member 1 and the second structural member 2 return to their original position. During this process, the first structural member 1 and the second structural member 2 cooperate to grip the sheet-like structure 4.

As shown in FIG. 2, which illustrates a schematic connection state when the decorative clip is mounted on the sheet-like structure 4, the first structural member 1 grips the upper surface of the sheet-like structure 4, while the second structural member 2 grips the lower surface.

The decorative clip provided in this embodiment can be attached to any position on any slat of the venetian blind and can be moved laterally relative to the slat, thereby allowing the position of the decorative item to be adjusted.

In some implementable embodiments, one side of the first structural member 1 is connected to the second structural member 2, and the side of the second structural member 2 opposite the connection is provided with a positioning structure 21. When the decorative clip is clamped onto the sheet-like structure 4, the positioning structure 21 is located above the edge of the sheet-like structure 4 (e.g., a slat), thereby preventing the decorative clip from slipping off.

In some implementable embodiments, the first structural member 1 is a protrusion-shaped sheet, and the second structural member 2 is a rectangular frame. The first structural member 1 grips the lower surface of the sheet-like structure 4, and the second structural member 2 grips the upper surface. A positioning structure 21 formed on the second structural member 2 hooks onto the slat to prevent the clip from slipping. The second structural member 2 is also connected to a decorative structure 3.

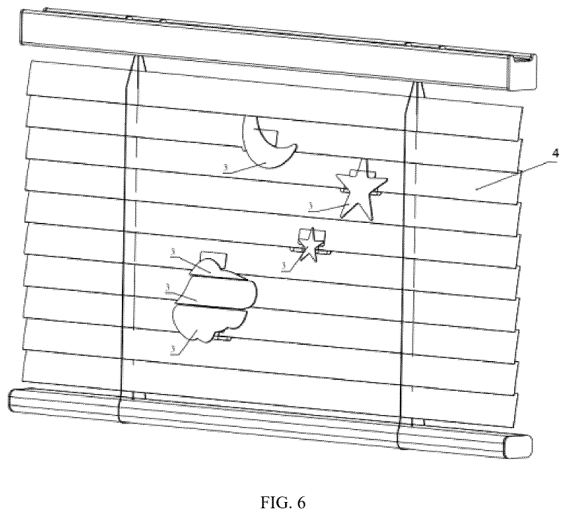

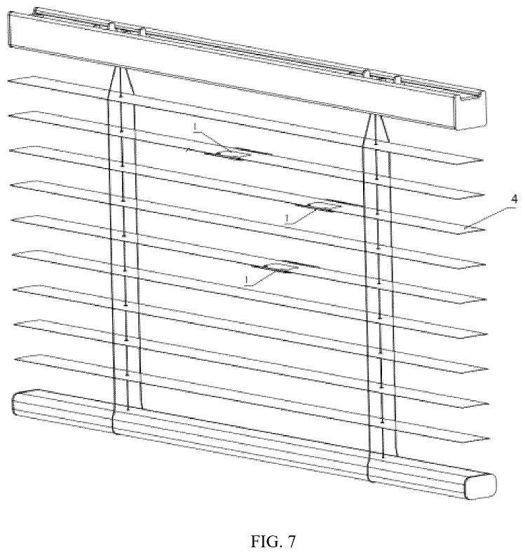

In some implementable embodiments, the decorative structure 3 is connected to the first structural member 1. Specifically, the decorative structure 3 may include decorative graphic structures, physical ornaments, or a combination thereof. When the decorative structure 3 is a decorative graphic structure, it is disposed on any end surface of the first structural member 1. More specifically, the decorative graphic structure can be attached to the first structural member 1 using adhesive bonding, riveting, or snap-fit connection, or a combination of these methods. When the decorative structure 3 is a physical ornament, it can likewise be fixed to the first structural member 1 using adhesive bonding, riveting, snap-fit, or combinations thereof. Specifically, the decorative structure 3 may take the form of a crescent (as shown in FIG. 4) or a five-pointed star (as shown in FIG. 5), among other shapes.

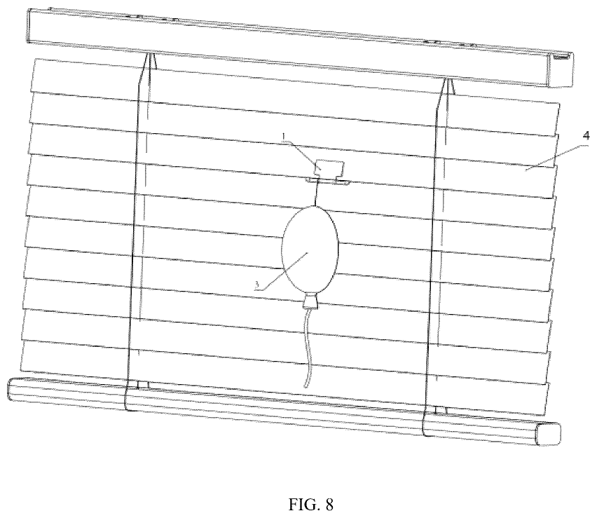

In any implementable embodiment, please refer to FIG. 8, the decorative structure 3 is connected to the first structural member 1 and/or the second structural member 2 via a connecting element. Specifically, the decorative structure 3 can be connected via a rope, adhesive strip, or similar means to the first structural member 1 and/or second structural member 2. This allows certain three-dimensional decorations to hang naturally on the venetian blinds, while still allowing normal operation of the blinds.

In any implementable embodiment, the decorative structure 3 can be detachably connected to the first structural member 1 and/or the second structural member 2. Specifically, this detachable connection may be achieved via magnetic attachment, snap-fit, threaded connection, or combinations thereof. For example, both the first structural member 1 and the second structural member 2 may be made of a material exhibiting habitual positioning behavior. The decorative structure 3 includes a magnetic element. The magnetic element can be magnetically adsorbed onto the first structural member 1 or the second structural member 2, allowing for interchangeable decorative structures depending on usage needs.

Compared with the prior art, the decorative clip provided by the present invention allows various decorative items to be arranged on venetian blinds without affecting their normal use. It is practical, marketable, and enhances the aesthetics of the blinds. It is also simple to operate, safe, and inexpensive to manufacture.

FIG. 6 illustrates the connection state of the decorative clip installed on a venetian blind slat when the blinds are in a closed position. The decorative structure 3 in this case may be a physical ornament or a puzzle-like configuration, highlighting the decorative effect.

The present invention also provides a curtain, which includes any one of the decorative clips described above. The curtain according to the present invention retains its normal usage functionality while also offering decorative features.

The above descriptions are merely preferred embodiments of the present invention and are not intended to limit the scope of the present invention. Any modifications, equivalent substitutions, or improvements made within the spirit and principle of the present invention shall fall within the scope of protection of the present invention.

1. A decorative clip, comprising:
a first structural member and a second structural member connected to the first structural member;
wherein, when subjected to an external force, an angular displacement is generated between the first structural member and the second structural member;
when the first structural member and the second structural member are positioned at a specific angle, a clamping force is generated therebetween, thereby enabling the clip to grip onto a sheet-like structure;
wherein a positioning structure is disposed on the side of the second structural member opposite to the side connected to the first structural member, to prevent slippage.

2. The decorative clip according to claim 1, wherein the first structural member is rigidly connected to one side of the second structural member.

3. The decorative clip according to claim 1, wherein the first structural member is movably connected to one side of the second structural member.

4. The decorative clip according to claim 2, wherein:
the first structural member is formed as a protrusion-shaped sheet, and the second structural member is a rectangular frame;
a protruding end of the protrusion-shaped sheet is connected to any position of the inner frame of the rectangular frame.

5. The decorative clip according to claim 4, wherein, when the decorative clip is clamped onto the sheet-like structure, the positioning structure is positioned higher than the edge of the sheet-like structure.

6. The decorative clip according to claim 1, further comprising a decorative structure connected to the first structural member and/or the second structural member.

7. The decorative clip according to claim 6, wherein the decorative structure is detachably connected to the first structural member and/or the second structural member.

8. The decorative clip according to claim 7, wherein the decorative structure is connected to the first structural member and/or the second structural member via a connector.

9. The decorative clip according to claim 2, wherein:
the first structural member is formed as a protrusion-shaped sheet, and the second structural member is a rectangular frame;
a protruding end of the protrusion-shaped sheet is connected to any position of the inner frame of the rectangular frame.

10. A curtain, comprising the decorative clip according to claim 1.

11. A curtain, comprising the decorative clip according to claim 2.

12. A curtain, comprising the decorative clip according to claim 3.

13. A curtain, comprising the decorative clip according to claim 4.

14. A curtain, comprising the decorative clip according to claim 5.

15. A curtain, comprising the decorative clip according to claim 6.

16. A curtain, comprising the decorative clip according to claim 7.

17. A curtain, comprising the decorative clip according to claim 8.

18. A curtain, comprising the decorative clip according to claim 9.
